(19) United States
(12) Patent Application Publication
(10) Pub. No.: US 2014/0368438 A1
(43) Pub. Date: Dec. 18, 2014

(54) TEST SYSTEM AND METHOD FOR TESTING KEYS OF VIRTUAL KEYPAD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: YA-GUO WANG, Shenzhen (CN); CHUN-CHING CHEN, New Taipei (TW)

(21) Appl. No.: 14/306,468

(22) Filed: Jun. 17, 2014

(30) Foreign Application Priority Data
Jun. 17, 2013 (CN) 2013102388873

(51) Int. Cl. G06F 3/02

(52) U.S. Cl. CPC G06F 3/02
USPC 345/168

(57) ABSTRACT

A test system and method for testing keys of a virtual keypad are applied to a touch screen which includes a plurality of keys. The test system includes a reading unit, a determination unit, and a display unit. The reading unit records the electrical performance when a key is touched and the determination unit calculates an error value as between the actual electrical performance obtained and a preset and required parameter associated with the key, and determines whether a key performs acceptably according to the calculated error value. The determination unit also determines whether the keypad itself is acceptable according to the performance of each of the keys, and the display unit displays a table recording the calculated error value, the status of each key, and the acceptability of the keypad overall.

### CROSS-REFERENCE TO RELATED APPLICATIONS

This application claims priority to Chinese Patent Application No. 201310238887.3 filed on Jun. 17, 2013 in the Chinese Intellectual Property Office, the contents of which are incorporated by reference herein.

### FIELD

The present disclosure relates to touch testing systems.

### BACKGROUND

A virtual keypad usually includes a plurality of keys. The keys must be tested to make sure the keys can work after the virtual keypad is assembled. Usually, the keys are tested one by one manually, which requires significant time and is inefficient.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a test system.

FIG. 2 is a table displayed on a display unit of the test system of FIG. 1.

FIG. 3 is a flowchart of an embodiment of the test system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure is in relation to a test system and method for testing keys of a virtual keypad. The test system includes a reading unit, a determination unit, and a display unit. The reading unit records the electrical performance when a key is touched and the determination unit calculates an error value as between the actual electrical performance obtained and a preset and required parameter associated with the key, and determines whether a key performs acceptably according to the calculated error value. The determination unit also determines whether the keypad itself is acceptable according to the performance of each of the keys, and the display unit displays a table recording the calculated error value, the status of each key, and the acceptability of the keypad overall.

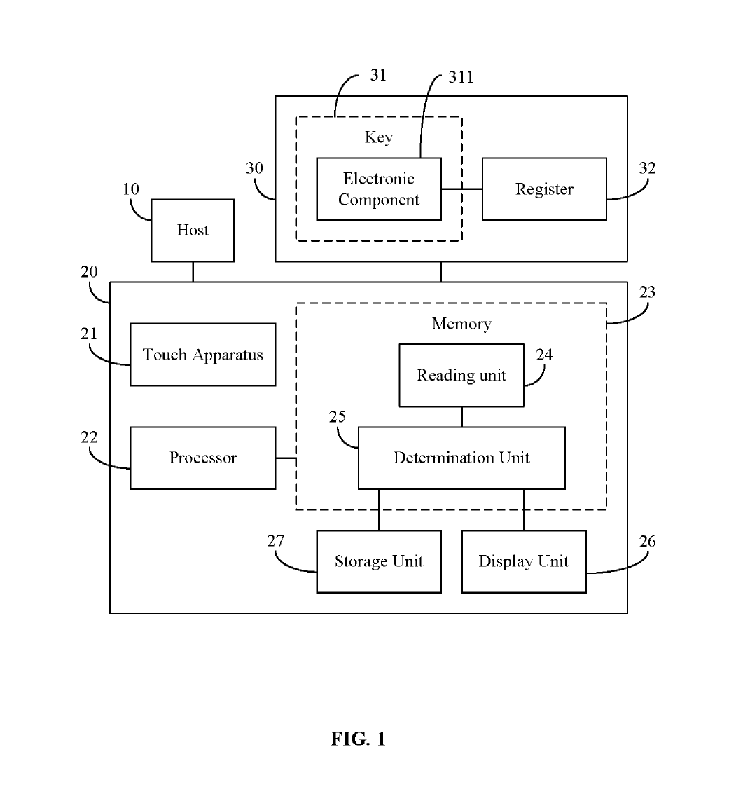

FIG. 1 illustrates an embodiment of a test system 20. The test system 20 can be electrically coupled to a host 10 and a virtual keypad 30. The virtual keypad 30 can include a plurality of keys 31 and a plurality of registers 32. Each of the keys 31 includes an electronic component 311, and each of the registers 32 is electrically coupled to the electronic component 311 of each of the keys 31. The test system 20 is used for testing the keys 31 and determining whether the performance of the virtual keypad 30 is acceptable in use.

The test system 20 includes a touch apparatus 21, a processor 22, a display unit 26 and a storage unit 27. The processor 22 executes instructions of a reading unit 24 and a determination unit 25, where the reading unit 24 and the determination unit 25 are stored in a memory 23. The touch apparatus 21 can be controlled by the host 10 to effectively provide a touch on the keys 31. In at least one embodiment, the touch apparatus 21 touches all of the keys 31 at almost the same time.

The storage unit 27 stores a number of preset performances as to electrical performance required. Each of the preset performances is associated with one of the electronic components 311. The storage unit 27 also stores a number of preset error values. Each of the preset error values is associated with one of the electronic components 311.

When a key is touched, physically or electronically, a register coupled to the key records an electrical activity of a corresponding electronic component. In at least one embodiment, the keys 31 are capacitively-operated keys, and the electronic components 311 are capacitive components. When one of the keys 31 is touched, a corresponding capacitive component is charged. A register coupled to the capacitive component records a charging time duration of the capacitive component. The reading unit 24 reads the charging time duration and sends the charging time duration to the determination unit 25.

The determination unit 25 first calculates an error value of each of the keys 31 between the obtained touch electrical activity and preset performance associated with an electronic component. In at least one embodiment, the determination unit 25 calculates an error value of each of the keys 31 between the obtained charging time duration and a preset charging time duration associated with a corresponding capacitive component.

The determination unit 25 determines whether the performance of a key is acceptable according to the calculated error value. In at least one embodiment, if the error value is no more than a preset error value associated with an electronic component of a key, the performance of the key is deemed acceptable. If the error value is greater than the preset error value, the key fails.

The determination unit 25 also determines whether the performance of the virtual keypad 30 is acceptable. If the performances of all the keys 31 are acceptable, the determination unit 25 determines that the performance of the virtual keypad 30 is acceptable overall. If one of the keys 31 fails, the determination unit 25 determines that the performance of the virtual keypad 30 is also a failure. Only when the performance of each of the keys 31 is acceptable, will the determination unit 25 determine that the performance of the virtual keypad 30 itself is acceptable.

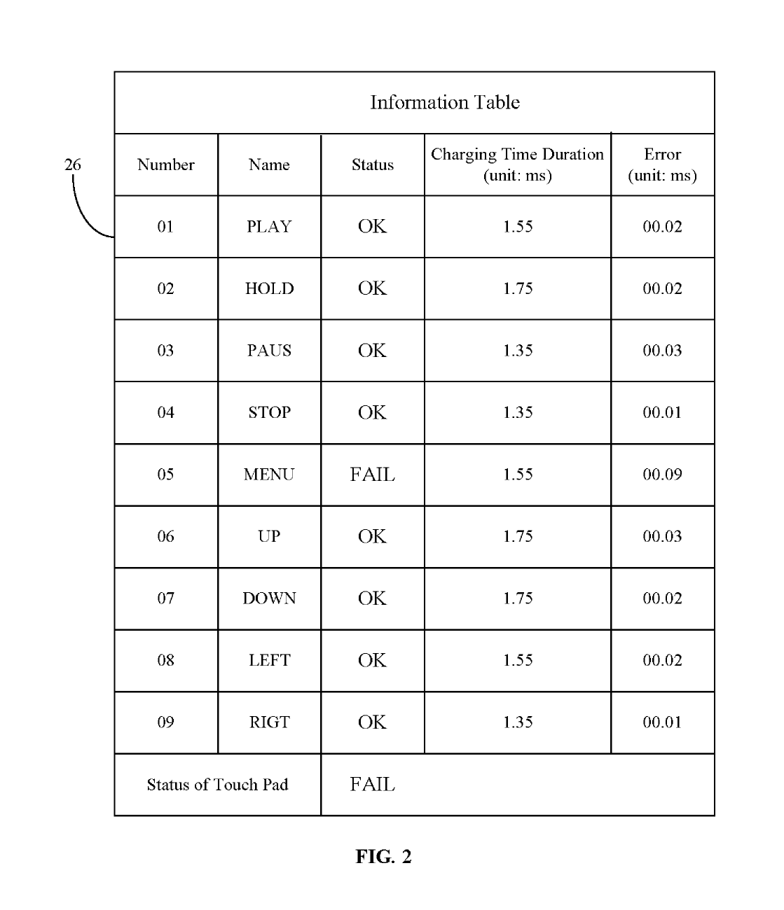

FIG. 2 illustrates a table 26 displayed on the display unit 26. The table 26 records a number of columns of information of the keys 31. The information can include “Number”, “Name”, “Performance”, “Charging Time Duration”, “Error” of the keys and “Performance of Virtual keypad”. In at least one embodiment, the information recorded in the “Charging Time Duration” column is obtained by the reading unit 24. The information recorded in the “Performance”, “Error” and “Performance of Virtual keypad” columns are determined by the determination unit 25.

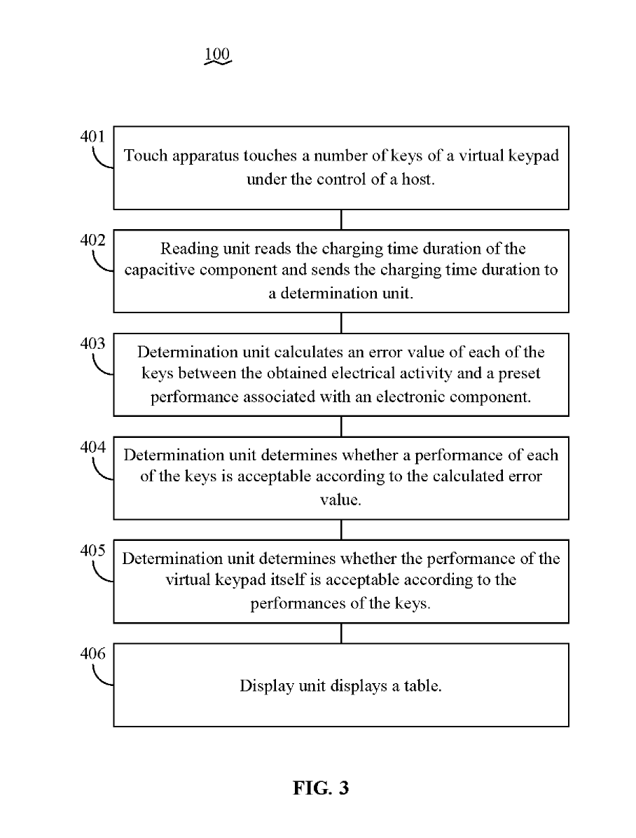

Referring to FIG. 3, a flowchart of an embodiment of an example method 100 is presented. The example method 100 is provided by way of example, as there are a variety of ways to carry out the embodiment. The example method 100 described below can be carried out using the configurations illustrated in FIG. 1, and various elements of these figures are referenced in explaining the example method 100. Each block shown in FIG. 3 represents one or more processes, methods, or subroutines, carried out in the exemplary method 100. Additionally, the illustrated order of blocks is by example only and the order of the blocks can change. The example method 100 can begin at block 401.

At block 401, a touch apparatus touches a number of keys of a virtual keypad under the control of a host. The virtual keypad also includes a number of registers. Each of the keys includes an electronic component, and each of the registers electrically coupled to an electronic component of each of the keys. In at least one embodiment, the keys are capacitively-operated keys, and the electronic component is a capacitive component. When one of the keys is touched, physically or electronically, a corresponding capacitive component starts charging. Then a register coupled to the capacitive component records an electrical activity of the capacitive component. In at least one embodiment, the register records a charging time duration of the capacitive component.

At block 402, a reading unit reads the charging time duration of the capacitive component and sends the charging time duration to a determination unit.

At block 403, the determination unit calculates an error value of each of the keys between the obtained electrical activity and a preset performance associated with an electronic component. In at least one embodiment, the determination unit calculates an error value of each of the keys between the obtained charging time duration and a preset charging time duration associated with a capacitive component.

At block 404, the determination unit determines whether a performance of each of the keys is acceptable according to the calculated error value. In at least one embodiment, if the error value is no more than a preset error value associated with an electronic component of a key, the performance of the key is deemed acceptable. If the error value is greater than the preset error value, the performance of the key is regarded as failing.

At block 405, the determination unit determines whether the performance of the virtual keypad itself is acceptable according to the performances of the keys. If all the keys have an acceptable performance, the determination unit determines that the performance of the virtual keypad is acceptable. If any key fails, the determination unit determines that the performance of the virtual keypad is fail.

At block 406, a display unit displays a table recording a number of columns of information of the keys. The information include “Number”, “Name”, “Performance”, “Charging Time Duration”, “Error” of the keys and “Performance of Virtual keypad”. in at least one embodiment, the information recorded in the “Charging Time Duration” column is obtained by the reading unit. The information recorded in the “Performance”, “Error” and “Performance of Virtual keypad” columns are determined by the determination unit.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular matters of shape, size and arrangement of the parts within the principles of the present disclosure, up to and including the full extent established by the broad general meaning of the terms used in the claims.

What is claimed is:

1. A test system for testing keys of a virtual keypad, the test system comprising:
a processor configured to execute instructions of the following units stored in a memory:
a reading unit having instructions to obtain an electrical activity of each of the keys of the virtual keyboard associated a detected touch of the corresponding key;
a determination unit having instructions to:
calculate an error value of each of the keys between the obtained electrical activity and a preset performance associated with the key stored in a storage unit,
determine the performance of the key is acceptable when the calculated error value is no more than a preset error value, and determine the performance of the key is a failure when the calculated error value is greater than the preset error value.

2. The test system of claim 1, wherein the determination unit also determines the performance of the virtual keypad is acceptable when all the keys have an acceptable performance, and determines the performance of the virtual keypad is fail when any key fails.

3. The test system of claim 2, further comprising a display unit configured to display a table recording the calculated error value of each of the keys, the performance of each of the keys and the performance of the virtual keypad.

4. The test system of claim 1, further comprising a touch apparatus configured to touch the keys under the control of a host.

5. A test system for testing keys of a virtual keypad, the test system comprising:
a reading unit configured to obtain an electrical activity of each of the keys when the key is touched; and
a determination unit configured to calculate an error value of each of the keys between the obtained electrical activity and a preset performance associated with the key stored in a storage unit, determine the performance of the key is acceptable when the calculated error value is no more than a preset error value, and determine the performance of the key is a failure when the calculated error value is greater than the preset error value.

6. The test system of claim 5, wherein the determination unit also determines the performance of the virtual keypad is acceptable when all the keys have an acceptable performance, and determines the performance of the virtual keypad is fail when any key fails.

7. The test system of claim 6, further comprising a display unit configured to display a table recording the calculated error value of each of the keys, the performance of each of the keys and the performance of the virtual keypad.

8. The test system of claim 5, further comprising a touch apparatus configured to touch the keys under the control of a host.

9. A test method for testing keys of a virtual keypad, the test method comprising:
obtaining an electrical activity of each of the keys when the key is touched;
calculating an error value of each of the keys between the obtained electrical activity and a preset performance associated with the key stored in a storage unit, and
determining the performance of the key is acceptable when the calculated error value is no more than a preset error value, and determine the performance of the key is a failure when the calculated error value is greater than the preset error value.

10. The test method of claim 9, further comprising determining the performance of the virtual keypad is acceptable when all the keys have an acceptable performance, and determines the performance of the virtual keypad is fail when any key fails.

11. The test method of claim 10, further comprising displaying a table recording the calculated error value of each of the keys, the performance of each of the keys and the performance of the virtual keypad.

12. The test method of claim 9, further comprising touching the keys under the control of a host.
